(19) United States
(12) Patent Application Publication
(10) Pub. No.: US 2011/0189974 A1
(43) Pub. Date: Aug. 4, 2011

(54) APPARATUS AND METHOD FOR REPORTING ACCIDENT IN PORTABLE TERMINAL

(75) Inventors: Eun-Hee PARK, Suwon-si (KR); Chang-Won SONG, Seoul (KR); Byung-Sam KIM, Hwaseong-si (KR)

(73) Assignee: SAMSUNG ELECTRONICS CO. LTD., Suwon-si (KR)

(21) Appl. No.: 12/961,967

(22) Filed: Dec. 7, 2010

(30) Foreign Application Priority Data
Jan. 29, 2010 (KR) 10-2010-0008358

(51) Int. Cl. H04M 11/04

(52) U.S. Cl. 455/404.2; 455/404.1

(57) ABSTRACT

An apparatus and a method of accident reporting in a portable terminal are provided. The method of accident reporting includes displaying a plurality of dangerous situation classification codes on a screen upon selection of a menu for reporting occurrence of a danger, selecting at least one dangerous situation classification code among the plurality of dangerous situation classification codes, requesting an input of an authentication number with respect to transmission of the selected dangerous situation classification code, and if the authentication code is valid, transmitting to a destination a specific message including a description of the selected dangerous situation classification code.

### PRIORITY

This application claims the benefit under 35 U.S.C. §119(a) of a Korean patent application filed in the Korean Intellectual Property Office on Jan. 29, 2010 and assigned Serial No. 10-2010-0008358, the entire disclosure of which is hereby incorporated by reference.

### BACKGROUND OF THE INVENTION

1. Field of the Invention

The present invention relates to a portable terminal. More particularly, the present invention relates to a method and an apparatus for reporting a dangerous situation in the portable terminal.

2. Description of the Related Art

With increase in various crimes, tools for preventing crimes or means for eliminating crimes have recently been proposed. For example, an emergency whistle, a tear gas gun, a high-voltage generator, an emergency light, etc., are proposed. However, these tools are not easy to use when the user directly confronts a criminal. In addition, when the user fails to scare away the criminal, the user has to directly face the criminal, which may result in a dangerous situation.

In dangerous situations where a person with a portable terminal witnesses a crime, the person can report the crime using the portable terminal and explain a crime site and location.

However, when the person reporting the crime faces a dangerous situation, such as a criminal incident, and thus the person vocally reports the dangerous situation using the portable terminal, the criminal can easily recognize the reporting of the dangerous situation. Thus, a more dangerous situation may occur or the criminal may run away from the scene of the crime. For example, when the person with the portable terminal is kidnapped and attempts to report this incident to the police vocally using the portable terminal, the person's voice may fail. In this case, the police may provide no help by considering this call as a prank call.

In addition, when a dangerous situation occurs, it may take a long time for the person to find the right department that handles such cases and to explain a location of the crime and the dangerous situation. As a result, a process of handling the dangerous situation may be delayed in an emergency situation.

Therefore, a need exists for a method and an apparatus for reporting a dangerous situation by adding a menu for reporting the dangerous situation in a portable terminal.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for reporting a dangerous situation by adding a menu for reporting the dangerous situation in a portable terminal.

Another aspect of the present invention is to provide a method and an apparatus for promptly handling an accident when a user reports the accident by using a portable terminal.

In accordance with an aspect of the present invention, a method of accident reporting in a portable terminal is provided. The method includes displaying a plurality of dangerous situation classification codes on a screen upon selection of a menu for reporting occurrence of a danger, selecting at least one dangerous situation classification code among the plurality of dangerous situation classification codes, requesting an input of an authentication number with respect to transmission of the selected dangerous situation classification code, and if the authentication code is valid, transmitting a specific message including a description of the selected dangerous situation classification code to a corresponding destination.

In accordance with another aspect of the present invention, a method of accident reporting in a portable terminal is provided. The method includes displaying a plurality of dangerous situation classification codes on a screen upon selection of a menu for reporting occurrence of a danger, selecting at least one dangerous situation classification code among the plurality of dangerous situation classification codes, searching for a phone number of a destination which receives the selected dangerous situation classification code, and transmitting a specific message including a description of the selected dangerous situation classification code to the destination based on the found phone number.

In accordance with another aspect of the present invention, an apparatus for accident reporting in a portable terminal is provided. The apparatus includes a display unit for displaying a plurality of dangerous situation classification codes on a screen upon selection of a menu for reporting occurrence of a danger, and a controller for selecting at least one dangerous situation classification code among the plurality of dangerous situation classification codes, for requesting an input of an authentication number with respect to transmission of the selected dangerous situation classification code, and if the authentication code is valid, for transmitting to a destination a specific message including a description of the selected dangerous situation classification code.

In accordance with another aspect of the present invention, an apparatus for accident reporting in a portable terminal is provided. The apparatus includes a display unit for displaying a plurality of dangerous situation classification codes on a screen upon selection of a menu for reporting occurrence of a danger, and a controller for selecting at least one dangerous situation classification code among the plurality of dangerous situation classification codes, for searching for a phone number of a destination which receives the selected dangerous situation classification code, and for transmitting a specific message including a description of the selected dangerous situation classification code to the destination based on the found phone number.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a method for accident reporting in a portable terminal according to an exemplary embodiment of the present invention;

FIG. 2 illustrates a method for accident reporting in a portable terminal according to an exemplary embodiment of the present invention;

FIG. 3 illustrates a menu screen for reporting a dangerous situation according to an exemplary embodiment of the present invention; and

FIG. 4 is a block diagram illustrating an apparatus for accident reporting in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

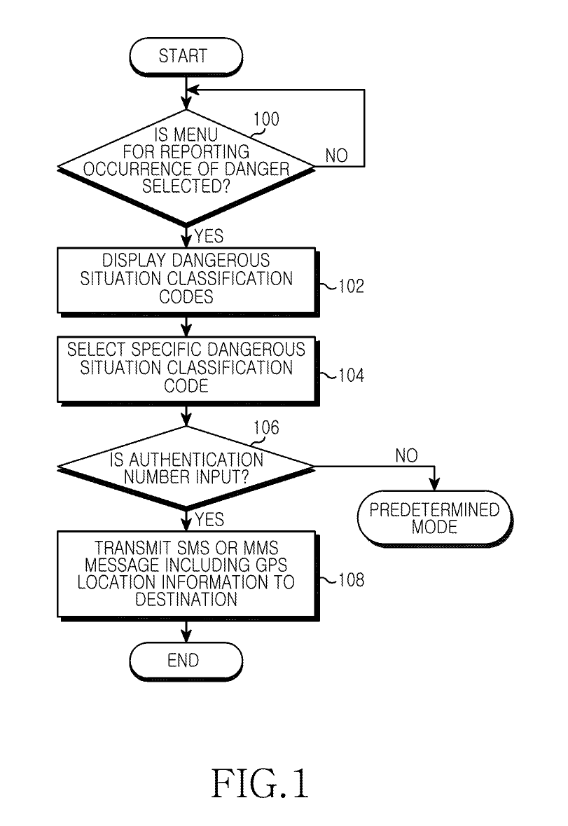

FIGS. 1 through 4, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

Exemplary embodiment of the present invention described below relate to a method and an apparatus for reporting a dangerous situation by adding a menu for reporting the dangerous situation in a portable terminal. More particularly, by providing a predefined dangerous situation classification code, the dangerous situation can be reported in such a manner that a reporter selects a code corresponding to the dangerous situation and transmits the code to a corresponding department which takes charge of the situation.

When the dangerous situation is reported by selecting the dangerous situation code from the menu for reporting the dangerous situation, location information is also transmitted together. In this case, a predefined photo of a user may also be attached and transmitted together with the location information. When the report is received in a reporting center and when personal information of the reporter, the location information, and a dangerous situation classification are recognized, the accident report is received in the corresponding department to handle the situation.

FIG. 1 illustrates a method for accident reporting in a portable terminal according to an exemplary embodiment of the present invention.

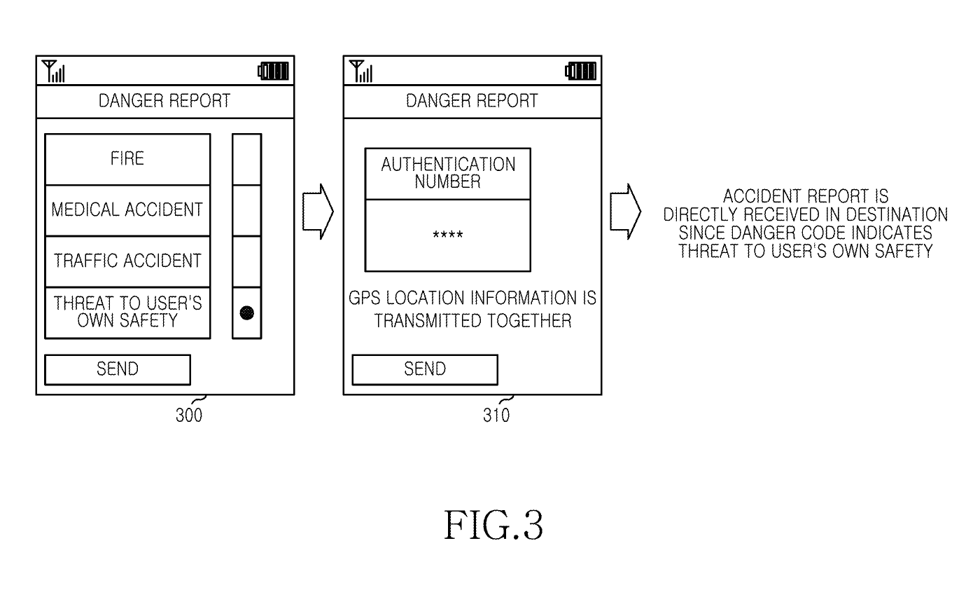

Referring to FIG. 1, when a user selects a menu for reporting occurrence of a danger in step 100, a portable terminal displays dangerous condition classification codes on a screen in step 102. Referring to FIG. 3 which illustrates a screen of the dangerous situation classification code, examples of the dangerous situation classification code include fire, medical accidents, traffic accidents, a threat to the user's safety, and the like. In step 300, the user selects a specific dangerous situation classification code (e.g., the threat to the user's safety).

If the dangerous situation classification codes are not entirely displayed on a full screen, the dangerous situation classification codes may be searched by scrolling up or down the display page on the screen of the portable terminal.

In step 104, the portable terminal allows the user to select the specific dangerous situation classification code. For example, the user selects one of the dangerous situation classification codes displayed on the screen in step 102. According to an implementation, the user may select a plurality of dangerous situation classification codes among the dangerous situation classification codes displayed on the screen.

In step 106, the portable terminal displays a menu for inputting an authentication number on the screen and waits until the user inputs the authentication number. Referring to FIG. 3, after the user selects at least one of the dangerous situation classification codes displayed on the screen in step 300, a window for inputting an authentication number is displayed on a next screen to prevent a prank report in step 310. The authentication number is a password defined in the portable terminal, or is an authenticated number received from an authentication system. Therefore, if the authentication number is the password defined in the portable terminal, the user receives the authentication number from the authentication system and then confirms and inputs the received authentication number. If the authentication number is the authenticated number received from the authentication system, the user receives the authentication number from the authentication system and then confirms and inputs the received authentication number.

According to an implementation, the process of step 106 for inputting the authentication number may be performed immediately when the menu for reporting the occurrence of the danger is selected in step 100. That is, the process of step 106 may be performed prior to the process of displaying the dangerous situation classification codes in step 102.

If it is determined in step 106 that the user inputs the authentication number, a Short Message Service (SMS) message or a Multimedia Messaging Service (MMS) message including Global Positioning System (GPS) location information of the portable terminal is transmitted to a destination in step 108 (e.g., a fire reporting center or a traffic accident reporting center). According to an implementation, in addition to the GPS location information, personal information stored in the portable terminal, e.g., a predefined photo of the user, may be transmitted. The predefined photo can be optionally selected by the user. When the SMS message is transmitted, the user can identify that the received message is a text for reporting a danger by using a Protocol IDentifier (PID) parameter value, and can transmit the dangerous situation classification code by using a User Data Header (UDH) value.

In contrast, if it is determined in step 106 that the user does not input the authentication number, a predefined mode is performed. The portable terminal waits until the authentication number is input in the predefined mode, or the menu of reporting the dangerous situation is terminated.

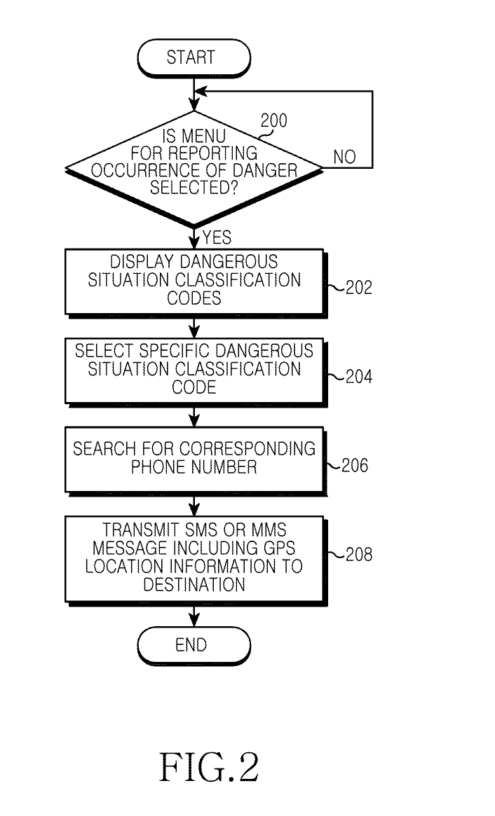

FIG. 2 illustrates a method for accident reporting in a portable terminal according to an exemplary embodiment of the present invention.

Referring to FIG. 2, when a user selects a menu for reporting occurrence of a danger in step 200, a portable terminal displays dangerous condition classification codes on a screen in step 202. In this case, if the dangerous situation classification codes are not entirely displayed on a full screen, the dangerous situation classification codes may be searched by scrolling up or down the display page on the screen of the portable terminal.

In step 204, the portable terminal allows the user to select a specific dangerous situation classification code. In step 206, the portable terminal searches for a phone number of a specific reporting center to which the selected dangerous situation classification code is transmitted.

According to an exemplary implementation, the process of step 206 for searching for the phone number of the specific reporting center may be performed immediately when the menu for reporting occurrence of the danger is selected in step 200. That is, the process of step 206 may be performed prior to the process of displaying the dangerous situation classification codes in step 202.

In step 208, the portable terminal transmits an SMS or MMS message including GPS location information to the specific reporting center using the found phone number of the specific reporting center. Optionally, in order to avoid a prank reporting call, a predefined photo of the user may be transmitted together with the GPS location information. When the SMS message is transmitted, the user can identify that the received message is a text for reporting a danger using a PID parameter value, and can transmit the dangerous situation classification code by using a UDH value.

FIG. 3 illustrates a menu screen for reporting a dangerous situation according to an exemplary embodiment of the present invention.

Referring to FIG. 3, when a user selects a menu for reporting occurrence of a danger, dangerous situation classification codes (e.g., fire, medical accidents, traffic accidents, a threat to the user's safety, and the like) are displayed on a screen of a portable terminal, in step 300. Herein, when the user selects one or more codes (e.g., the threat to the user's safety) from the displayed dangerous situation classification codes, a window for inputting an authentication number is displayed on a next screen, in step 310. The authentication number is a password defined in the portable terminal, or is an authenticated number provided from an authentication server.

When the authentication number is correctly input, the dangerous situation classification code, GPS location information, personal information (e.g., user's photo), etc., are transmitted together to a reporting center. Upon receiving the dangerous situation classification code, the reporting center recognizes and handles an accident corresponding to the dangerous situation classification code.

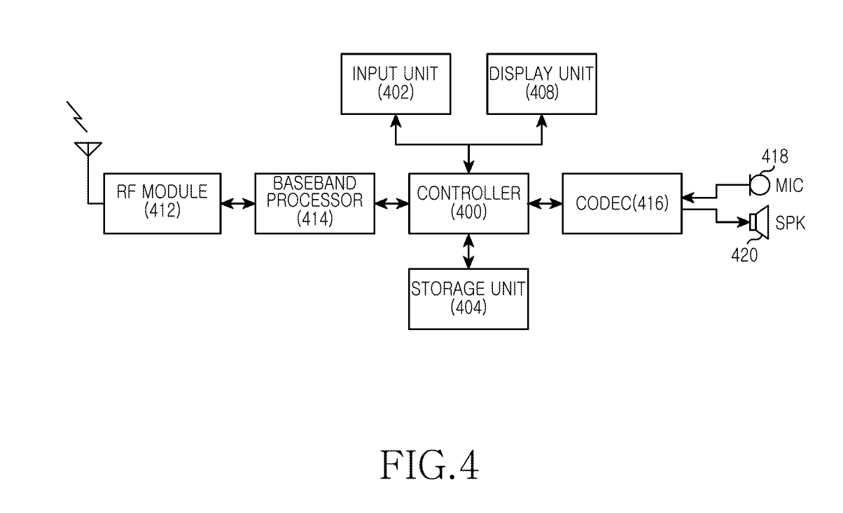

FIG. 4 is a block diagram illustrating an apparatus for accident reporting in a portable terminal according to an exemplary embodiment of the present invention.

Referring to FIG. 4, a portable terminal includes a controller 400, an input unit 402, a display unit 408, a Radio Frequency (RF) module 412, a baseband processor 414, a storage unit 404, and a COder-DECoder (CODEC) 416.

The controller 400 provides overall control to the portable terminal. For example, the controller 400 processes and controls voice telephony and data communication. In addition to its typical function, according to an exemplary embodiment of the present invention, the controller 400 performs a control function and a function of reporting occurrence of a danger based on a menu selection for reporting the occurrence of the danger.

For example, when the user selects the menu for reporting the occurrence of the danger, the controller 400 controls the display unit 408 to display dangerous situation classification codes. When the user selects a specific dangerous situation classification code, a screen for inputting an authentication number is displayed in the display unit 408. The authentication number is a password defined in the portable terminal, or is an authenticated number provided from an authentication system. When a correct authentication number is input, the selected dangerous situation classification code, GPS location information, and personal information are transmitted to a specific reporting center by using an SMS or MMS message.

The selected dangerous situation classification code is mapped to phone number information of the specific reporting center. Thus, the SMS or MMS message is transmitted to the specific reporting center by referring to the phone number mapped to the selected dangerous situation classification code.

The storage unit 404 stores a microcode of a program, by which the controller 400 is processed and controlled, and a variety of reference data. More particularly, in addition to its typical function, according to an exemplary embodiment of the present invention, the storage unit 404 stores the dangerous situation classification codes.

Further, the storage unit 404 is a working memory of the controller 400 and stores temporary data that is generated while programs are performed. Furthermore, the storage unit 404 stores a variety of rewritable data, such as phonebook entries, outgoing messages, incoming messages, and the like.

The input unit 402 includes a plurality of function keys, such as numeral keys of ‘0’ to ‘9’, a menu key, a cancel key (or a delete key), an OK key, a talk key, an end key, an Internet access key, a navigation key (or a direction key), etc. Key input data (e.g., a password, an authentication number, etc.), which is input when the user presses these keys, is provided to the controller 400.

The display unit 408 displays information, such as state information, which is generated while the portable terminal operates, limited numeric characters, large volumes of moving and still pictures, etc. The display unit 408 may be a color Liquid Crystal Display (LCD). For example, in an exemplary embodiment of the present invention, the display unit 408 displays the dangerous situation classification codes or displays a window for inputting an authentication number under the control of the controller 400.

A speaker (SPK) 420 and a microphone (MIC) 418, each of which is connected to the CODEC 416, are voice input/output blocks used for telephony and voice recording.

The CODEC 416 converts Pulse Code Modulation (PCM) data provided from the controller 100 into an analog voice signal and transmits the analog data through the speaker 420. Further, the CODEC 416 converts a voice signal received through the microphone 418 into PCM data and provides the PCM data to the controller 400.

The RF unit 412 converts an RF signal received through an antenna by decreasing a frequency of the signal and provides the converted signal to the baseband processor 414. Further, the RF unit 412 converts a baseband signal provided from the baseband processor 414 by increasing a frequency of the signal and transmits the converted signal through the antenna.

The baseband processor 414 processes a baseband signal transmitted and received between the RF unit 412 and the controller 400. For example, in a transmitting process, data to be transmitted is subject to a channel-coding process and a spreading process. In a receiving process, a received signal is subject to a de-spreading process and a channel-decoding process.

As described above, since a menu for reporting occurrence of a danger is used to transmit a dangerous situation classification code by using an SMS or MMS message, a user can ask for help without having to make a call, and a location of the user and personal information of the user can be easily recognized. In addition, in a case where an attempt to make a call to 119, which is equivalent to 911 in the United States of America, or other equivalent number is impossible at a dangerous situation, a reporting menu can be used for rapid reporting. When a report is received, personal information and location information are directly transmitted along with a cell phone number, and thus a possibility of prank calls is low and an accident can be easily detected. Further, the accident can be directly reported to a department taking charge of the accident by using the dangerous situation classification code.

According to exemplary embodiments of the present invention, since a dangerous situation can be reported using a portable terminal, there is an advantage in that the dangerous situation can be reported to a department taking charge of a corresponding accident.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of accident reporting in a portable terminal, the method comprising:
displaying a plurality of dangerous situation classification codes on a screen upon selection of a menu for reporting occurrence of a danger;
selecting at least one dangerous situation classification code among the plurality of dangerous situation classification codes;
requesting an input of an authentication number with respect to transmission of the selected dangerous situation classification code; and
if the authentication code is valid, transmitting a specific message including a description of the selected dangerous situation classification code to a corresponding destination.

2. The method of claim 1, wherein the dangerous situation classification codes are mapped to descriptions pre-defined for respective dangerous situations.

3. The method of claim 1, wherein the specific message is one of a Short Message Service (SMS) message and a Multimedia Messaging Service (MMS) message.

4. The method of claim 1, further comprising:
inserting at least one of user's personal information and location information to the specific message.

5. The method of claim 4, wherein the personal information includes at least one of a user's name, a user's resident registration number, and a user's photo.

6. The method of claim 1, wherein the authentication number comprises at least one of a password of the portable terminal and an authorized number received from an authentication server.

7. The method of claim 1, further comprising:
adding, changing, or deleting the dangerous situation classification code.

8. A method of accident reporting in a portable terminal, the method comprising:
displaying a plurality of dangerous situation classification codes on a screen upon selection of a menu for reporting occurrence of a danger;
selecting at least one dangerous situation classification code among the plurality of dangerous situation classification codes;
searching for a phone number of a destination which receives the selected dangerous situation classification code; and
transmitting a specific message including a description of the selected dangerous situation classification code to the destination based on the found phone number.

9. The method of claim 8, wherein the dangerous situation classification codes are mapped to descriptions pre-defined for respective dangerous situations.

10. The method of claim 8, wherein the specific message is one of a Short Message Service (SMS) message and a Multimedia Messaging Service (MMS) message.

11. The method of claim 8, further comprising:
inserting at least one of user's personal information and location information to the specific message.

12. The method of claim 11, wherein the personal information includes at least one of a user's name, a user's resident registration number, and a user's photo.

13. The method of claim 8, further comprising:
inputting an authentication number before transmitting the specific message to the destination, wherein the authentication number comprises at least one of a password of the portable terminal and an authorized number received from an authentication server.

14. The method of claim 8, further comprising:
adding, changing, or deleting the dangerous situation classification code.

15. An apparatus for accident reporting in a portable terminal, the apparatus comprising:
a display unit for displaying a plurality of dangerous situation classification codes on a screen upon selection of a menu for reporting occurrence of a danger; and
a controller for selecting at least one dangerous situation classification code among the plurality of dangerous situation classification codes, for requesting an input of an authentication number with respect to transmission of the selected dangerous situation classification code, and if the authentication code is valid, for transmitting to a destination a specific message including a description of the selected dangerous situation classification code.

16. The apparatus of claim 15, wherein the dangerous situation classification codes are mapped to descriptions pre-defined for respective dangerous situations.

17. The apparatus of claim 15, wherein the specific message is one of a Short Message Service (SMS) message and a Multimedia Messaging Service (MMS) message.

18. The apparatus of claim 15, wherein the controller inserts at least one of user's personal information and location information to the specific message.

19. The apparatus of claim 18, wherein the personal information includes at least one of a user's name, a user's resident registration number, and a user's photo.

20. The apparatus of claim 15, wherein the authentication number comprises at least one of a password of the portable terminal and an authorized number received from an authentication server.

21. The apparatus of claim 15, wherein the controller adds, changes, or deletes the dangerous situation classification code.

22. An apparatus for accident reporting in a portable terminal, the apparatus comprising:
a display unit for displaying a plurality of dangerous situation classification codes on a screen upon selection of a menu for reporting occurrence of a danger; and
a controller for selecting at least one dangerous situation classification code among the plurality of dangerous situation classification codes, for searching for a phone number of a destination which receives the selected dangerous situation classification code, and for transmitting a specific message including a description of the selected dangerous situation classification code to the destination based on the found phone number.

23. The apparatus of claim 22, wherein the dangerous situation classification codes are mapped to descriptions pre-defined for respective dangerous situations.

24. The apparatus of claim 22, wherein the specific message is one of a Short Message Service (SMS) message and a Multimedia Messaging Service (MMS) message.

25. The apparatus of claim 22, wherein the controller inserts at least one of user's personal information and location information to the specific message.

26. The apparatus of claim 25, wherein the personal information includes at least one of a user's name, a user's resident registration number, and a user's photo.

27. The apparatus of claim 22,
wherein the controller inputs an authentication number before transmitting the specific message to the destination, and
wherein the authentication number comprises at least one of a password of the portable terminal and an authorized number received from an authentication server.

28. The apparatus of claim 22, wherein the controller adds, changes, or deletes the dangerous situation classification code.
